(19) United States
(12) Patent Application Publication
(10) Pub. No.: US 2024/0211462 A1
(43) Pub. Date: Jun. 27, 2024

(54) CONSOLIDATING CHANGES ON A HIERARCHICAL STRUCTURE TO MINIMIZE A NUMBER OF DATA REQUESTS

(71) Applicant: VMware, Inc., Palo Alto, CA (US)

(72) Inventors: Ventsyslav RAIKOV, Sofia (BG); Atanas TODOROV, Sofia (BG); Marin DZHIGAROV, Sofia (BG)

(21) Appl. No.: 18/145,535

(22) Filed: Dec. 22, 2022

(51) Int. Cl. G06F 16/23; G06F 16/22; G06F 16/27

(52) U.S. Cl. CPC G06F 16/2358; G06F 16/2246; G06F 16/27

(57) ABSTRACT

The disclosure provides an approach for efficient resource information retrieval. Embodiments include receiving, by a resource management component, a batch of change records related to a plurality of computing resources. Embodiments include determining, based on one or more entity updates in the batch of change records, a set of unique updated entities. Embodiments include, for each relationship update that updates a given relationship between a given computing resource and a given tier, removing the given computing resource from the set and adding the given tier to the set and, for each relationship update that updates a respective relationship between a respective tier and a respective application, removing the respective tier from the set and adding the respective application to the set. Embodiments include sending, to a resource analysis component, a request for information about each entity in the set and receiving the requested information.

### BACKGROUND

A software-defined data center (SDDC) may comprise a plurality of hosts in communication over a physical network infrastructure. Each host is a physical computer (machine) that may run one or more virtualized endpoints such as virtual machines (VMs), containers, and/or other virtual computing instances (VCIs). In some cases, VCIs are connected to software-defined networks, (SDNs) also referred to herein as logical overlay networks, that may span multiple hosts and are decoupled from the underlying physical network infrastructure. An SDDC may be connected to external endpoints, such as cloud services, via a network such as the Internet.

A resource analysis component for tracking metrics, analyzing performance, and/or maintaining configuration information of computing resources (e.g., VCIs running in an SDDC) may be located within an SDDC or at a remote location (e.g., on a cloud server connected to the SDDC). Such a resource analysis component may gather and publish data related to performance and configuration of computing resources, such as for consumption by a resource management component through which a user views and manages information about the computing resources (e.g., via a user interface associated with the resource management component). In some cases, computing resources (e.g., VCIs running in an SDDC) may be grouped into constructs called tiers, such as based on relationships among the computing resources, in order to allow for more efficient and organized management of the computing resources. For example, a set of VCIs that communicate with each other for a shared purpose, such as implementing load balancing functionality, data storage functionality, logging fucntionality, and/or the like, may be grouped into a tier. Furthermore, multiple tiers may be grouped into a construct called an application. An application may include multiple tiers that work together for a common overarching purpose, such as content management, software development, messaging, web browsing, system management, and/or the like. For example, a content management application may involve multiple tiers, such as a database tier and a load balancing tier, that work together for managing content. In some cases, a user of the resource analysis component may provide configuration information that defines groupings of computing resources into tiers and groupings of tiers into applications, and these groupings are used to track metrics and configuration information related to the computing resources.

In order for the resource management component to maintain up-to-date information about resources, tiers, and applications as configuration changes occur, it may fetch the current state of the applications from the resource analysis component, such as via application programming interface (API) calls from the resource management component. However, due to the potentially large amount of changes that may occur in any given time period, the number of API calls and responses between the resource management component and the resource analysis component can grow quite large, and the amount of data transferred can place a significant burden on physical computing resources involved, such as processing, memory, and network resources.

Accordingly, there is a need in the art for improved techniques for maintaining up-to-date information about hierarchically organized computing resources at a resource management component in a manner that makes efficient use of physical computing resources as changes occur at a resource analysis component.

### BRIEF DESCRIPTION OF THE DRAWINGS

FIG. 1 depicts example physical and virtual network components with which embodiments of the present disclosure may be implemented.

FIG. 2 depicts an example of efficient computing resource information retrieval according to embodiments of the present disclosure.

FIG. 3 depicts another example related to efficient computing resource information retrieval according to embodiments of the present disclosure.

FIG. 4 depicts example operations for efficient computing resource information retrieval according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for efficient computing resource information retrieval. In particular, techniques described herein involve consolidating changes on a hierarchical structure of computing resources in order to minimize requests and responses.

In an example, a resource analysis component running on one or more cloud servers maintains information about computing resources such as VCIs running in an SDDC connected to the resource analysis component via a network. The information may include, for example, configuration values of the computing resources (e.g., name, type, geographic region, and/or the like) and data related to performance of the computing resources (e.g., processor, memory, and network utilization, latency, throughput, and/or the like). In some cases, the resource analysis component receives information about computing resources running in an SDDC from an agent running in the SDDC. The resource analysis component may automatically determine the hierarchical structure of the computing resources, such as grouping computing resources into tiers and grouping tiers into applications or it may receive this configuration information from a user. Updates with respect to the computing resources, tiers, and applications may be published by the resource analysis component as they occur, such as to a “topic” of a publishing service, which data consuming entities (e.g., a resource management component) may poll or subscribe to in order to receive the updates. The updates may include entity updates, which comprise changes to entities such as computing resources, tiers, and applications, and relationship updates, which comprise changes to hierarchical relationships among entities. An example of an entity update is a change to a display name of a computing resource. An example of a relationship update is the adding of a computing resource to a tier.

While the resource management component could request all information related to all computing resources, tiers, and applications from the resource analysis component as needed, such as whenever a user access a user interface associated with the resource management component, this approach would be slow and inefficient (e.g., the amount of data being transferred from the resource analysis component to the resource management component at once would be high and result in poor performance). As such, embodiments of the present disclosure involve periodic, incremental data collection by the resource management component and storage of periodically-collected data in a database associated with the resource management component. In particular, techniques described herein involve hierarchical consolidation of data requests based on the entity updates and relationship updates published by the resource analysis component.

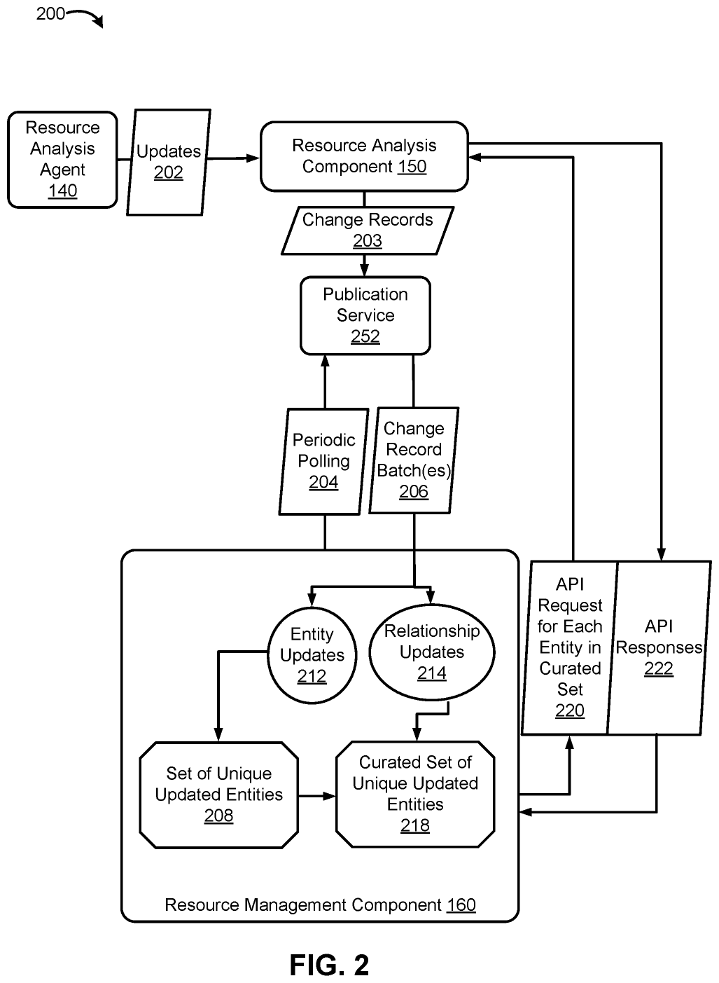

In a particular example, as described in more detail below with respect to FIG. 2, the resource management component periodically polls a publication service (e.g., topic) to which updates are published by the resource analysis component to obtain a batch of change records, which may include records of entity updates and relationship updates. The resource management component then determines a set of unique entities that are updated by entity updates in the batch of change records. Subsequently, the resource management component curates the set of unique entities based on relationship updates in the batch of change records. For example, if a relationship update adds or removes a computing resource to or from a tier, the resource management component removes the computing resource from the set (if it is in the set) and adds the tier to the set (if it is not already in the set). Similarly, if a relationship update adds or removes a tier to or from an application, the resource management adds the application to the set (if it is not already in the set) and removes the tier from the set (if it is in the set). Thus, the set of unique entities is collapsed on a hierarchical basis so that only the highest-level component known to be affected by each entity update, as determined based on the relationship updates, is included in the set. The resource management component then uses the curated set to send requests (e.g., API requests) to the resource analysis component only for information about the entities included in the set, rather than separately requesting information about each individual entity that was updated in the batch of change records.

Embodiments of the present disclosure constitute a technical improvement with respect to existing techniques for maintaining information about computing resources at a resource management component. For example, by periodically requesting data about entities that have changed from a resource analysis component rather than requesting all data every time a user accesses the resource management component, techniques described herein avoid excessively large transfers of data that decrease performance and monopolize physical computing resources. Additionally, by curating a set of unique updated entities to include only the highest-level entities in a hierarchical structure known to be affected by each entity update in a periodically collected batch of change records, techniques described herein reduce the numbers of requests and responses transmitted between the resource management component and the resource analysis component and thereby improve the functioning of the computing devices involved while allowing up-to-date resource information to be utilized for resource management.

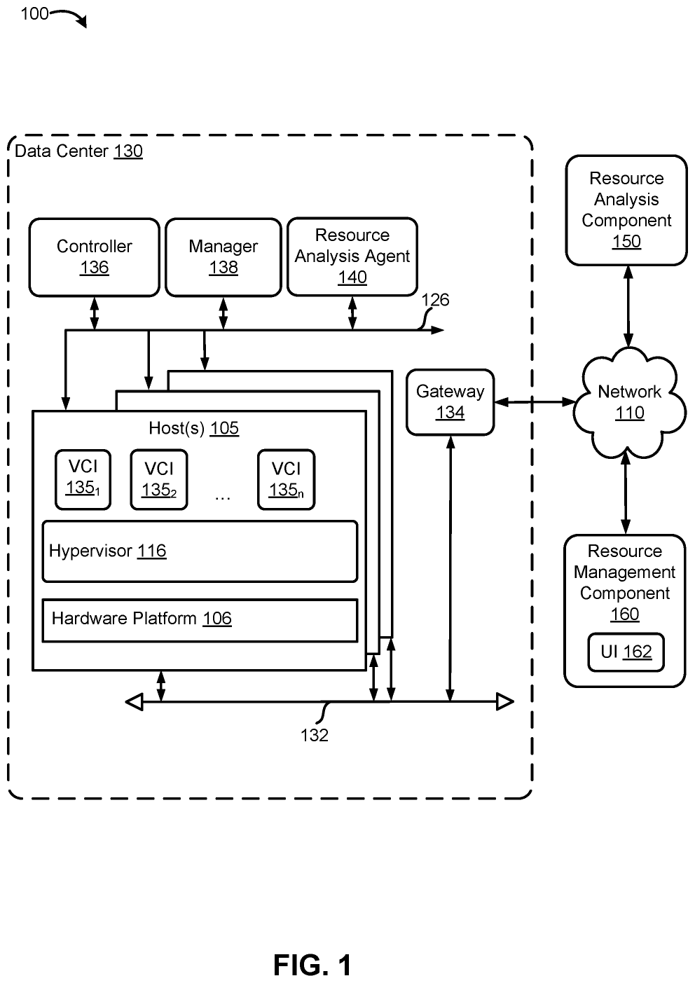

FIG. 1 depicts example physical and virtual network components with which embodiments of the present disclosure may be implemented.

Networking environment 100 includes data center 130, a resource analysis component 150, and a resource management component 160 connected to network 110. Network 110 is generally representative of a network of machines such as a local area network (“LAN”) or a wide area network (“WAN”), a network of networks, such as the Internet, or any connection over which data may be transmitted.

Resource analysis component 150 generally represents a component that collects metrics and configuration information of computing resources, such as VCIs 135 running on hosts 105 in data center 130. One example of a network analytics provider that may be represented by resource analysis component 150 is the vRealize® suite (e.g., vRealize® Network Insight (VRNI) available from VMware®), although other types of resource analysis components may also or alternatively be used.

Resource management component 160 generally represents a component that performs management functionality for computing resources, such as VCIs 135 running on hosts 105 in data center 130. One example of a cloud management system that may be represented by resource management component 160 is the vRealize® Automation (vRA) cloud automation software from VMware®, although other types of resource management components may also or alternatively be used.

For example, resource management component 160 may obtain information about computing resources from resource analysis component 150 using techniques described herein, and may display information about computing resources, tiers, and applications to a user via a user interface (UI) 162 for use in resource management. In some embodiments, each of resource analysis component 150 and resource management component 160 runs on one or more computing devices such as servers (e.g., cloud servers). In some cases, resource analysis component 150 and/or resource management component 160 may be implemented in a distributed manner across multiple physical computing devices.

Data center 130 generally represents a set of networked machines, and may comprise a logical overlay network. Data center 130 includes host(s) 105, a gateway 134, a data network 132, which may be a Layer 3 network, and a management network 126. Host(s) 105 may be an example of machines. Data network 132 and management network 126 may be separate physical networks or different virtual local area networks (VLANs) on the same physical network.

It is noted that, while not shown, additional data centers may also be connected to data center 130 via network 110.

Each of hosts 105 may include a server grade hardware platform 106, such as an x86 architecture platform. For example, hosts 105 may be geographically co-located servers on the same rack or on different racks. Host 105 is configured to provide a virtualization layer, also referred to as a hypervisor 116, that abstracts processor, memory, storage, and networking resources of hardware platform 106 for multiple virtual computing instances (VCIs) 1351 to 135n (collectively referred to as VCIs 135 and individually referred to as VCI 135) that run concurrently on the same host. VCIs 135 may include, for instance, VMs, containers, virtual appliances, and/or the like. VCIs 135 may be an example of machines. VCIs 135 may also be an example of computing resources.

In certain aspects, hypervisor 116 may run in conjunction with an operating system (not shown) in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. In certain aspects, hypervisor 116 implements one or more logical entities, such as logical switches, routers, etc. as one or more virtual entities such as virtual switches, routers, etc. In some implementations, hypervisor 116 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine. In certain embodiments, applications may run on host 105 without the use of a hypervisor.

Resource analysis agent 140 is a component that gathers data related to VCIs 135, such as network traffic, performance and/or configuration information. For example, resource analysis agent 140 may run on one of hosts 105, such as on a VCI 135. In some embodiments, resource analysis agent 140 is one component of a distributed resource analysis system that analyses network traffic and gathers configuration and metrics for endpoints throughout data center 130. Resource analysis agent 140 acts as an agent of resource analysis component 150, gathering information about computing resources in data center 130 (e.g., through interaction with hypervisors 116 and/or other components in data center 130) and providing the information to resource analysis component 150 (e.g., via network 119).

Gateway 134 provides VCIs 135 and other components in data center 130 with connectivity to network 110, and is used to communicate with destinations external to data center 130, such as resource analysis component 150 and resource management component 160. Gateway 134 may be implemented as one or more VCIs, physical devices, and/or software modules running within one or more hosts 105.

Controller 136 generally represents a control plane that manages configuration of VCIs 135 within data center 130. Controller 136 may be a computer program that resides and executes in a central server in data center 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of data center 130. Controller 136 communicates with hosts 105 via management network 126.

Manager 138 represents a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In one embodiment, manager 138 is a computer program that executes in a central server in networking environment 100, or alternatively, manager 138 may run in a VCI, e.g. in one of hosts 105. Manager 138 is configured to receive inputs from an administrator or other entity, e.g., via a web interface or API, and carry out administrative tasks for data center 130, including centralized network management and providing an aggregated system view for a user.

As described in more detail below with respect to FIGS. 2-4, resource management component 160 may optimize performance by reducing the number of data requests it sends to resource analysis component for data related to computing resources, tiers, and applications.

FIG. 2 is an illustration 200 of an example of efficient computing resource information retrieval according to embodiments of the present disclosure. Illustration 200 includes resource analysis agent 140, resource analysis component 150, and resource management component 160 of FIG. 1.

Resource analysis agent 140 provides updates 202 to resource analysis component 150. Updates 202 may include, for example, configuration and metric updates with respect to computing resources, such as VCIs. Resource analysis component 150 publishes change records 202, based at least in part on updates 202, via a publication service 252. Change records 203 generally represent changes to entities (e.g., computing resources, tiers, and/or applications), which may include changes that are indicated in updates 202, and/or changes to relationships (e.g., adding/removing computing resources from tiers, adding/removing tiers from applications, and/or the like), which may be based on user input via resource analysis component 150. Publication service 252 may, for example, be the Apache® Kafka® platform, and change records 203 may be published to a Kafka® topic. Other types of publication services may alternatively be used. Publication service 252 may run on the same device as resource analysis component 150 and/or may run on one or more different devices (e.g., on one or more cloud servers).

Resource management component 160 performs periodic polling 204 of publication service 252 in order to obtain change record batches 206. For example, resource management component 160 may send a request to publication service 252 at regular intervals (e.g., according to a configured interval, such as for batches having a batch size configured at resource management component 160) and receive a change record batch 206 in response to each request. Alternatively, resource management component 160 may subscribe to publication service 252, such as to receive change record batches 206 at regular intervals. In some embodiments, the interval and batch size may be configured at resource management component 160.

Each change record batch 206 may include one or more entity updates 212 and/or one or more relationship updates 214. Entity updates 212 comprise changes to computing resources, tiers, or applications and relationship updates 214 comprise changes to memberships of tiers or applications. For example, an entity update 212 may comprise a creation of an entity such as a VCI or a change to a parameter of an entity, such as a change to a display name of a VCI. An example of a relationship update 214 is the addition of a computing resource to a tier.

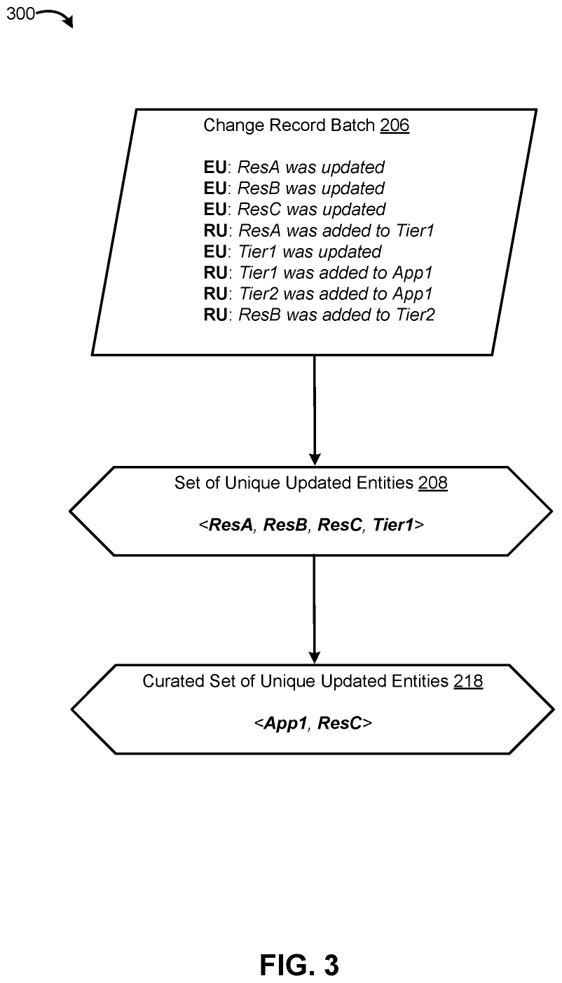

For each change record batch 206, resource management component 160 creates a set of unique updated entities 208 based on the entity updates 212 in the change record batch 206. As described in more detail below with respect to FIG. 3, the set of unique updated entities 208 includes all computing resources, tiers, and applications that are updated by entity updates 212. Resource management component 160 then curates the set of unique updated entities 208 based on relationship updates 214 to produce a curated set of unique updated entities 218. As described in more detail below with respect to FIG. 3, the curation process may involve collapsing entities on a hierarchical basis according to relationship updates 214. For example, if a relationship update 214 comprises adding a computing resource to a tier or removing a computing resource from a tier, the computing resource may be removed from and the tier may be added to the curated set of unique updated entities 218. If a relationship update 214 comprises adding a tier to an application or removing a tier from an application, the tier may be removed from and the application may be added to the curated set of unique updated entities 218. Also, if an application is deleted (e.g., via an entity update), then that application may be removed from the curated set (and the application may also be deleted from the database at resource management component 160).

Resource management component 160 then sends an application programming interface (API) request 220 to resource analysis component 150 only for each entity in curated set of unique updated entities 218 rather than sending API requests for all entities in the original set of unique updated entities 208. Resource analysis component 150 responds to API requests 220 with API responses 222, such as including the requested information (e.g., which may include parameters of each entity in the curated set). It is noted that API requests and responses are included as one example of a technique for requesting and receiving information about entities, and other types of requests and responses may alternatively be used. Similarly, while computing resources, tiers, and applications are included as examples of hierarchical entity types, other types of entities may alternatively be used.

FIG. 3 is an illustration 300 of another example related to efficient computing resource information retrieval according to embodiments of the present disclosure. Illustration 300 includes change record batch 206, set of unique updated entities 208, and curated set of unique updated entities 218 of FIG. 2.

Change record batch 206 includes a series of entity updates (EUs) and relationship updates (RUs). The EUs include updates to computing resources called ResA, ResB, and ResC and an update to a tier called Tier1. Each EU may indicate creation of entity, an update to a parameter of an entity, and/or the like. The RUs include indications that ResA was added to Tier1, Tier1 was added to an application called App1, a tier called Tier2 was added to App1, and ResB was added to Tier2.

The set of unique updated entities 208 includes each unique entity that was updated by an EU in change record batch 206, including ResA, ResB, ResC, and Tier1. The set of unique updated entities 208 is then curated based on the RUs in change record batch 206 in order to produce the curated set of unique updated entities 218. In some embodiments, all RUs between computing resources and tiers are processed first and then all RUs between tiers and applications are processed.

For example, because an RU indicates that ResA was added to Tier1, ResA is removed from the set and Tier1 is added to the set. Additionally, because a subsequent RU indicates that ResB was added to Tier2, ResB is removed from the set and Tier2 is added to the set. Subsequently, because an RU indicates that Tier1 was added to App1, Tier1 is removed from the set and App1 is added to the set. Then, because a subsequent RU indicates that Tier2 was added to App1, Tier2 is removed from the set and, because App1 is already in the set, it does not need to be added. Accordingly the final curated set of unique updated entities 218 includes App1 and ResC.

Sending API requests for each entity in the curated set of unique update entities 218, which includes only two entities, is more resource-efficient than sending API requests for each entity in the original set of unique updated entities 208, which includes four entities. In practice the number of entities in the original set is likely to be much larger than the number of entities in the curated set. Furthermore, sending API requests for each entity in the curated set of unique update entities 218 at regular intervals is more resource-efficient than other techniques for information retrieval such as requesting information about all entities each time the resource management component is accessed or requesting information about all entities at regular intervals. Thus, techniques described herein improve performance of the computing devices involved, reduce latency, and allow a resource management component to receive and maintain up-to-date information about all entities managed by the resource management component.

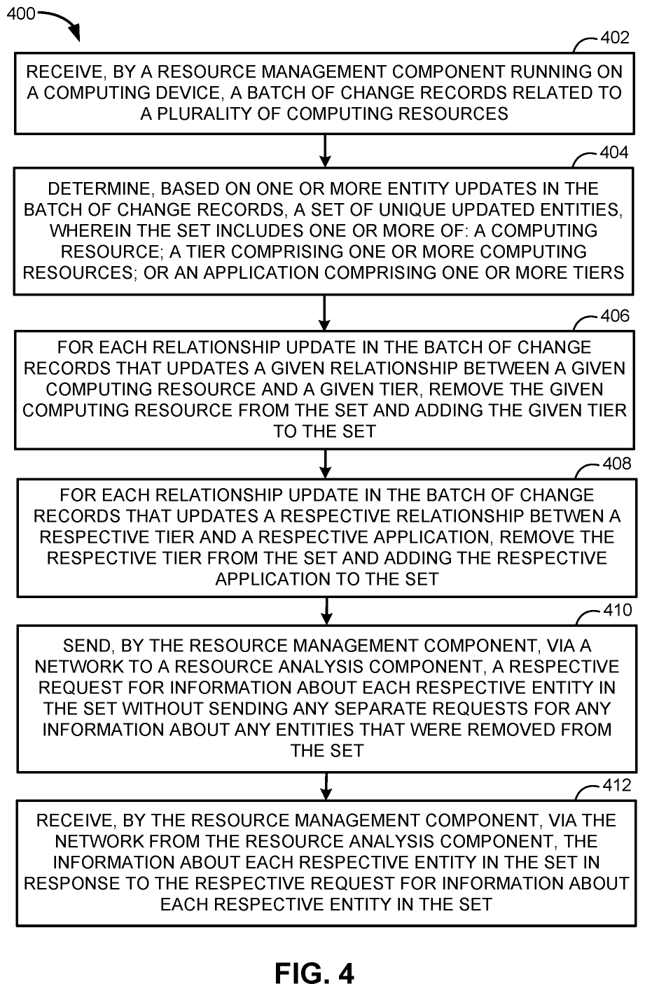

FIG. 4 depicts example operations 400 for efficient computing resource information retrieval according to embodiments of the present disclosure. For example, operations 400 may be performed by resource management component 160 and/or resource analysis component 150 of FIGS. 1 and 2.

Operations 400 begin at step 402, with receiving, by a resource management component running on a computing device, a batch of change records related to a plurality of computing resources. In some embodiments, receiving the batch of change records related to the plurality of computing resources is based on polling, by the resource management component, a service based on an interval and a batch size.

Operations 400 continue at step 404, with determining, based on one or more entity updates in the batch of change records, a set of unique updated entities, wherein the set includes one or more of: a computing resource; a tier comprising one or more computing resources; or an application comprising one or more tiers. In some embodiments, each computing resource in the set comprises a virtual computing instance (VCI).

Operations 400 continue at step 406, with, for each relationship update in the batch of change records that updates a given relationship between a given computing resource and a given tier (e.g., adds a given computing resource to a given tier or removes the given computing resource from the given tier), removing the given computing resource from the set and adding the given tier to the set.

Operations 400 continue at step 408, with, for each relationship update in the batch of change records that updates a respective relationship between a respective tier and a respective application (e.g., adds a respective tier to a respective application or removes the respective tier from the respective application), removing the respective tier from the set and adding the respective application to the set.

Some embodiments further comprise, for each entity update in the batch of change records that deletes a particular application, removing the particular application from the set.

Operations 400 continue at step 410, with sending, by the resource management component, via a network to a resource analysis component, a respective request for information about each respective entity in the set without sending any separate requests for any information about any entities that were removed from the set.

In some embodiments, sending, by the resource management component, via the network to the resource analysis component, the respective request for information about each respective entity in the set comprises making one or more calls to an application programming interface (API) associated with the resource analysis component.

Operations 400 continue at step 412, with receiving, by the resource management component, via the network from the resource analysis component, the information about each respective entity in the set in response to the respective request for information about each respective entity in the set.

In some embodiments, receiving, by the resource management component, via the network from the resource analysis component, the information about each respective entity in the set comprises receiving, for a particular application, corresponding information about all tiers and all computing resources within the particular application.

Certain embodiments further comprise providing, by the resource management component, output via a user interface based on the information about each respective entity in the set.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of efficient resource information retrieval, comprising:
receiving, by a resource management component running on a computing device, a batch of change records related to a plurality of computing resources;
determining, based on one or more entity updates in the batch of change records, a set of unique updated entities, wherein the set includes one or more of:
a computing resource;
a tier comprising one or more computing resources; or
an application comprising one or more tiers;
for each relationship update in the batch of change records that updates a given relationship between a given computing resource and a given tier, removing the given computing resource from the set and adding the given tier to the set;
for each relationship update in the batch of change records that updates a respective relationship between a respective tier and a respective application, removing the respective tier from the set and adding the respective application to the set;
sending, by the resource management component, via a network to a resource analysis component, a respective request for information about each respective entity in the set without sending any separate requests for any information about any entities that were removed from the set; and
receiving, by the resource management component, via the network from the resource analysis component, the information about each respective entity in the set in response to the respective request for information about each respective entity in the set.

2. The method of claim 1, wherein each computing resource in the set comprises a virtual computing instance (VCI).

3. The method of claim 1, further comprising, for each entity update in the batch of change records that deletes a particular application, removing the particular application from the set.

4. The method of claim 1, wherein receiving, by the resource management component, the batch of change records related to the plurality of computing resources is based on polling, by the resource management component, a service based on an interval and a batch size.

5. The method of claim 1, wherein receiving, by the resource management component, via the network from the resource analysis component, the information about each respective entity in the set comprises receiving, for a particular application, corresponding information about all tiers and all computing resources within the particular application.

6. The method of claim 1, further comprising providing, by the resource management component, output via a user interface based on the information about each respective entity in the set.

7. The method of claim 1, wherein sending, by the resource management component, via the network to the resource analysis component, the respective request for information about each respective entity in the set comprises making one or more calls to an application programming interface (API) associated with the resource analysis component.

8. A system for efficient resource information retrieval, the system comprising:
at least one memory; and
at least one processor coupled to the at least one memory, the at least one processor and the at least one memory configured to:
receive, by a resource management component running on a computing device, a batch of change records related to a plurality of computing resources;
determine, based on one or more entity updates in the batch of change records, a set of unique updated entities, wherein the set includes one or more of:
a computing resource;
a tier comprising one or more computing resources; or
an application comprising one or more tiers;
for each relationship update in the batch of change records that updates a given relationship between a given computing resource and a given tier, remove the given computing resource from the set and add the given tier to the set;
for each relationship update in the batch of change records that updates a respective relationship between a respective tier and a respective application, remove the respective tier from the set and add the respective application to the set;
send, by the resource management component, via a network to a resource analysis component, a respective request for information about each respective entity in the set without sending any separate requests for any information about any entities that were removed from the set; and
receive, by the resource management component, via the network from the resource analysis component, the information about each respective entity in the set in response to the respective request for information about each respective entity in the set.

9. The system of claim 8, wherein each computing resource in the set comprises a virtual computing instance (VCI).

10. The system of claim 8, wherein the at least one processor and the at least one memory are further configured to, for each entity update in the batch of change records that deletes a particular application, remove the particular application from the set.

11. The system of claim 8, wherein receiving, by the resource management component, the batch of change records related to the plurality of computing resources is based on polling, by the resource management component, a service based on an interval and a batch size.

12. The system of claim 8, wherein receiving, by the resource management component, via the network from the resource analysis component, the information about each respective entity in the set comprises receiving, for a particular application, corresponding information about all tiers and all computing resources within the particular application.

13. The system of claim 8, wherein the at least one processor and the at least one memory are further configured to provide, by the resource management component, output via a user interface based on the information about each respective entity in the set.

14. The system of claim 8, wherein sending, by the resource management component, via the network to the resource analysis component, the respective request for information about each respective entity in the set comprises making one or more calls to an application programming interface (API) associated with the resource analysis component.

15. A non-transitory computer-readable medium storing instructions that, when executed by one or more processors, cause the one or more processors to:
receive, by a resource management component running on a computing device, a batch of change records related to a plurality of computing resources;
determine, based on one or more entity updates in the batch of change records, a set of unique updated entities, wherein the set includes one or more of:
a computing resource;
a tier comprising one or more computing resources; or
an application comprising one or more tiers;
for each relationship update in the batch of change records that updates a given relationship between a given computing resource and a given tier, remove the given computing resource from the set and add the given tier to the set;
for each relationship update in the batch of change records that updates a respective relationship between a respective tier and a respective application, remove the respective tier from the set and add the respective application to the set;
send, by the resource management component, via a network to a resource analysis component, a respective request for information about each respective entity in the set without sending any separate requests for any information about any entities that were removed from the set; and
receive, by the resource management component, via the network from the resource analysis component, the information about each respective entity in the set in response to the respective request for information about each respective entity in the set.

16. The non-transitory computer-readable medium of claim 15, wherein each computing resource in the set comprises a virtual computing instance (VCI).

17. The non-transitory computer-readable medium of claim 15, wherein the instructions, when executed by the one or more processors, further cause the one or more processors to, for each entity update in the batch of change records that deletes a particular application, remove the particular application from the set.

18. The non-transitory computer-readable medium of claim 15, wherein receiving, by the resource management component, the batch of change records related to the plurality of computing resources is based on polling, by the resource management component, a service based on an interval and a batch size.

19. The non-transitory computer-readable medium of claim 15, wherein receiving, by the resource management component, via the network from the resource analysis component, the information about each respective entity in the set comprises receiving, for a particular application, corresponding information about all tiers and all computing resources within the particular application.

20. The non-transitory computer-readable medium of claim 15, wherein the instructions, when executed by the one or more processors, further cause the one or more processors to provide, by the resource management component, output via a user interface based on the information about each respective entity in the set.
